(19) United States
(12) Patent Application Publication
(10) Pub. No.: US 2008/0294763 A1
(43) Pub. Date: Nov. 27, 2008

(54) DISPLAY OUTPUT SETTING METHOD, INFORMATION PROCESSING DEVICE, AND INFORMATION PROCESSING SYSTEM

(76) Inventor: Hideki Uchida, Fukuoka (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/056,772

(22) Filed: Mar. 27, 2008

(30) Foreign Application Priority Data
May 21, 2007 (JP) 2007-133627

(51) Int. Cl. G06F 21/00; G06F 15/173

(52) U.S. Cl. 709/223; 726/3

(57) ABSTRACT

An information processing device which executes steps of transmitting a request of specification information of a display device connected to a terminal via a network, receiving the specification information of a display device connected to the terminal, determining display output set values suitable for the specifications of the display device from the terminal on the basis of the specification information of the display device and display output set values for the specifications of the display device stored in a display output set value management table, setting the determined display output set values in a display output set value file, receiving input information of the terminal via the network, generating display information on the basis of the input information and the display output set values stored in the display output set value file, and transmitting the generated display information to the terminal via the network.

### INCORPORATION BY REFERENCE

The present application claims priority from Japanese application JP2007-133627 filed on May 21, 2007, the content of which is hereby incorporated by reference into this application.

### BACKGROUND OF THE INVENTION

The present invention relates to an information processing system of a thin client type and more particularly, to a technique for automatically setting a display output of a display (display device) connected to a terminal.

As part of information leak prevention in companies, corporations, etc., such companies or corporations as to introduce an information processing system of a thin client type are increasing in number in these years. In the thin client type of information processing system, such an information processing device as a client blade processes information entered from a keyboard or mouse of a thin client terminal and display information as its processed result is transmitted to the thin client terminal. That is, a so-called an information processing system of a display transmission type is established. Such systems include a point-to-point type having a thin client terminal and an information processing device as a conventional art PC (personal computer) both connected in a 1:1 relation, and a point-to-blade type having a terminal and a blade type PC both connected in a 1:1 relation via a management server.

Even when a company or incorporation employs any of such system types, an authentication device such as a key mobile having information for identifying one of a plurality of users stored therein and an information processing device are allocated to each private user, so that the plurality of users can commonly use a client terminal. When such a system type as mentioned above is used and each user goes out to a business trip or customer company or site, each user can access the information processing device allocated to the user by carrying only the authentication device and using both the information processing device allocated to the user and a terminal located at the company or the like as his business trip site. In addition, a so-called free address work style having no fixed seat even in a workplace is also expanding. In this case, each user can selectively use different types of terminals such as installation and mobile types of terminals according to the use environment of the selected terminal, with the result in that even the specifications of a display device connected to the terminal also correspondingly vary each time.

In the conventional information processing system display of the transmission type, an information processing device generates display information using input information received from a terminal and a display output set value previously stored in the information processing device. For this reason, the display output set value is not always a value optimum for the specification of a display device connected to the terminal. When the set value is not optimum for the specifications, an improper display information appears on the display device, which results in that it is difficult for the user to use the display device due to the improper display information. When the display device is set at a small value of resolution, in particular, the display screen of the information on a display device having a large diagonal inch measurement (referred to as the inch size) and a large maximum resolution causes a defect such as a dot to appear on the display screen. In the conventional art system, the defect is handled and resolved, each time the specifications of a display device vary, by changing the display output set value utilizing a function (standard function of an OS (operating system)) of changing the display output set value previously stored in the information processing device and with use of an input unit such as a keyboard or a mouse. For this reason, such operation is highly inconvenience and troublesome to the user.

The aforementioned problem can be considered to be unique to the above display transmission type communication, because a thin client is different from a usual PC in respects which are given below.

In a usual PC use, a peripheral device connected to the main body of the PC is automatically detected based on a plug & play function and controlled by the PC. In the display transmission type communication, on the other hand, a thin client and an information processing device are connected through a network not by the plug & play function.

In the conventional PC use, basically, information is collected at the terminal side directly operated by the user. In the display transmission type communication, however, it is required to collect information held in a terminal operated by the user into the information processing device.

A method of controlling a device via a network is disclosed in U.S. Pat. No. 6,523,696. The network is arranged to collect information on the specifications of devices such as a plurality of devices (e.g., video decks) connected with an information processing device on the assumption that the network is based on IEEE (The Institute of Electrical and Electronics Engineers, Inc.) 1394 or the like having a single address space. A plug & play function is attained in the restricted network configuration when a distance between the information processing device and the devices is short mainly as inside homes or the like.

In JP-A-2006-134245, a user directly operates a conventional PC to collect information and transmits the collected information from the PC to an information processing device. In other words, such a device as to collect information stored in the information processing device into the terminal for its utilization is employed in JP-A-2006-134245.

### SUMMARY OF THE INVENTION

In an information processing system of a thin client type, such a technique as to automatically set a display output suitable for the specifications of a changed display device when one display device is changed to another display device has been demanded. However, any of the aforementioned related techniques fails to be based on the information processing system of the thin client type. In U.S. Pat. No. 6,523,696, a range of collection of information on device specifications depends on the characteristic of a network. In JP-A-2006-134245, a user directly collects information in a terminal used by the user. Any of the literatures fails to consider the above respect.

It is therefore an object of the present invention to provide a technique for automatically set a display output suitable for the specifications of a changed display (display device) even when one display device is changed to another display device in an information processing system of a thin client type.

In accordance with an aspect of the present invention, the above problem is resolved by providing an information processing device which is connected to a plurality of terminals via a network to execute operations which follow. The information processing device first transmits a request of display specifications information to the terminals via the network. The information processing device then determines display output set values (color, resolution, etc.) suitable for the specifications (inch size, maximum resolution, etc.) of a display device connected to the terminal, on the basis of information on the specifications of the display device connected to the terminal therefrom and display output set values for the specifications of each of display devices stored in a management table of display output set values. The information processing device next generates display information (on the desk top screen of the display device) with use of the determined display output set values and input information (about the contents of operations of a keyboard or mouse), and transmits the display information to the terminal via the network.

In another aspect of the invention, an information processing device connected to a plurality of terminals via a network executes operations which follow. The information processing device first transmits a request of information on the specifications of a display device to the terminal via the network. The information processing device then determines whether or not the information about the display device specifications is stored in a management table of display output set values. When determining that the display device specification information is stored in the management table as its determination result, the information processing device refers to information about update date and time of the display device output set values for the specifications of each of display devices stored in the management table. When determining that the update date and time for the received display device specification information are not the latest, the information processing device determines display output set values suitable for the specifications of the display device on the basis of the received display device specification information and the display output set values for the specifications of the corresponding display device stored in the management table. The information processing device next sets the determined display output set values in a display output set value file. The information processing device generates display information (on the desk top screen of the display device on the basis of input information (about the contents of operations of a keyboard or mouse) from the terminal and the display output set values set in the display output set value file, and transmits the generated display information to the terminal via the network.

In accordance with the present invention, even when display device specifications are changed in the information processing system of the thin client type, such a technique as to automatically set a display output suitable for the specifications of the changed display device can be provided. Thus there can be provided an information processing system of a thin client terminal which can have a good handleability by eliminating the need for a user to manually change the display output set values.

Other objects, features and advantages of the invention will become apparent from the following description of the embodiments of the invention taken in conjunction with the accompanying drawings.

### BRIEF DESCRIPTION OF THE DRAWINGS

FIG. 1 shows an example of a schematic configuration of an information processing system 1000 in accordance with a first embodiment of the present invention;

FIG. 2 is a diagram for explaining a summary of operation of the information processing system 1000;

FIG. 3 shows an example of a schematic arrangement of a terminal 1;

FIG. 4 shows an example of a schematic structure of a display specification information management table 145;

FIG. 5 shows an example of a schematic arrangement of an authentication device 2;

FIG. 6 shows an example of a schematic structure of profile information 5013;

FIG. 7 shows an example of a schematic arrangement of an information processing device 4;

FIG. 8 shows an example of a schematic structure of an authentication information management table 446;

FIG. 9 shows an example of a schematic structure of a display output set value management table 447;

FIG. 10 shows an example of a schematic structure of a display output set value file 448;

FIG. 11 shows operation of the information processing system 1000;

FIG. 12 shows other operation of the information processing system 1000;

FIG. 13 shows yet other operation of the information processing system 1000;

FIG. 14 shows an example of a list of profile information appearing on a display screen;

FIG. 15 is a flow chart of operations of determining display output set values on the basis of display specification information from the terminal 1 and information stored in the display output set value management table 447 and updating the set contents of the display output set value file 448;

FIG. 16 shows an example of changed display output set values on the display screen;

FIG. 17 shows an example of a display screen prompting a user to confirm the set value change;

FIG. 18 shows an example of a schematic configuration of an information processing system in accordance with a second embodiment of the present invention;

FIG. 19 shows an example of a schematic arrangement of a management device 1802;

FIG. 20 shows an example of a schematic structure of an allocation table 19045;

FIG. 21 shows an example of a schematic structure of a display output set value management table 2100; and

FIG. 22 is a flow chart showing processing operation of a display output set value change program in third and fourth embodiments of the invention.

### DETAIL DESCRIPTION OF THE EMBODIMENTS

A first embodiment of the present invention will be explained.

### Embodiment 1

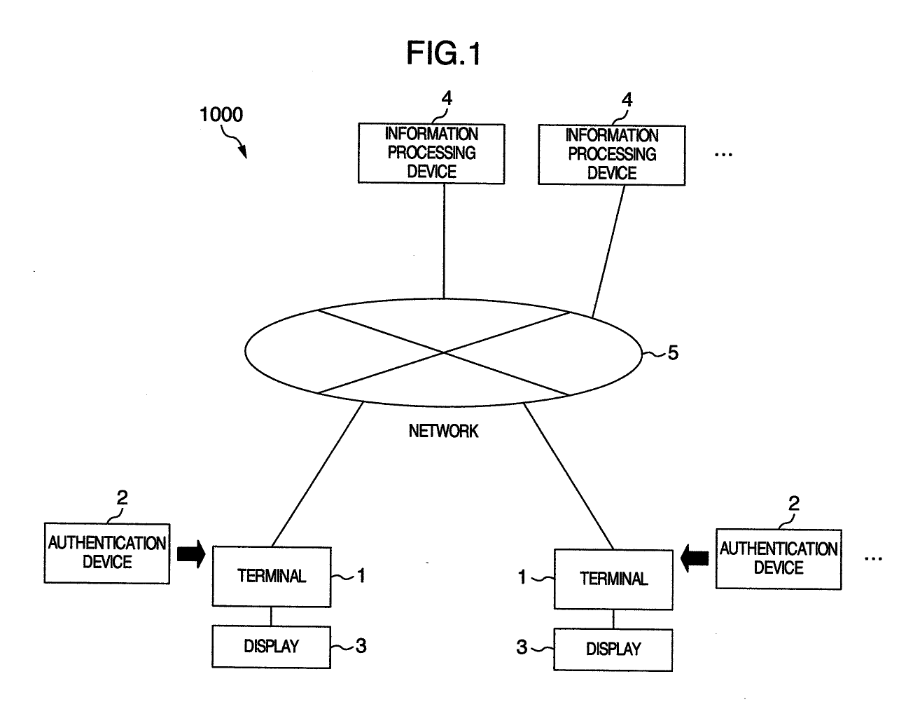

FIG. 1 shows an example of a schematic configuration of an information processing system in accordance with a first embodiment of the present invention.

An information processing system 1000 according to the present embodiment, which is of a point-to-point connection type, includes a plurality of terminals 1, a plurality of authentication devices (authentication media) 2, and a plurality of information processing devices 4. Each terminal 1 has a display (display device) 3 connected thereto. Each information processing device 4 is connected to a network 5 such as a LAN (Local Area Network).

The terminal 1 is a so-called client terminal not having an HDD (Hard Disk Drive) mounted therein. The terminals 1 include mobile and desktop types. The authentication device 2, which is removably mounted to the terminal 1, stores authentication information (e.g., user ID, password) necessary for user authentication to be used in the authentication device itself and in the information processing device 4 respectively, and information about the IP (Internet Protocol) address (internet address) of the information processing device 4 as a terminal 1 connection destination device. As a result, a third person other than the true owner of the authentication device 2 cannot access the information processing device 4. Each information processing device 4 is a PC provided with an HDD having software stored therein to provide a terminal service for the terminal 1. Such an information processing device 4 is installed on the user own desk.

It is assumed in the present embodiment that one of the authentication devices 2 and one of the information processing devices 4 are allocated to each user. It is also assumed that the terminals 1 and the display devices 3 connected to the terminals 1 are not allocated to the individual users but shared by the plural users. The terminals 1 and the information processing devices 4 may be installed at a remote site so long as these terminals and processors can establish TCP/IP (Transmission Control Protocol/Internet Protocol) based communication via the network 5. The network 5 may be of a mixed type including a plurality of networks, so long as the terminals 1 and the information processing devices 4 can establish TCP/IP based mutual communication. In such an information processing system 1000, when each user carries his authentication device 2 and goes out to a base site where the terminal 1 is installed, the user can access the information processing device 4 allocated to the user with use of the carried authentication device 2 and the installed terminal 1.

As will be detailed later, the information processing device 4 in the present embodiment transmits a request of display specification information to the terminal 1 via the network 5, determines display output set values (color, resolution, etc.) suitable for the specifications (inch size, maximum resolution, etc.) of the display 3 connected to the terminal 1 on the basis of the display specification information received from the terminal 1 via the network 5 and display output set values for the specifications of each display device stored in the information processing device 4, generates display information (to be displayed on the desktop display screen of the display device) with use of the determined display output set values and input information (about the contents of operations of a keyboard or mouse) from the terminal 1, and transmits the generated information to the terminal 1 via the network 5.

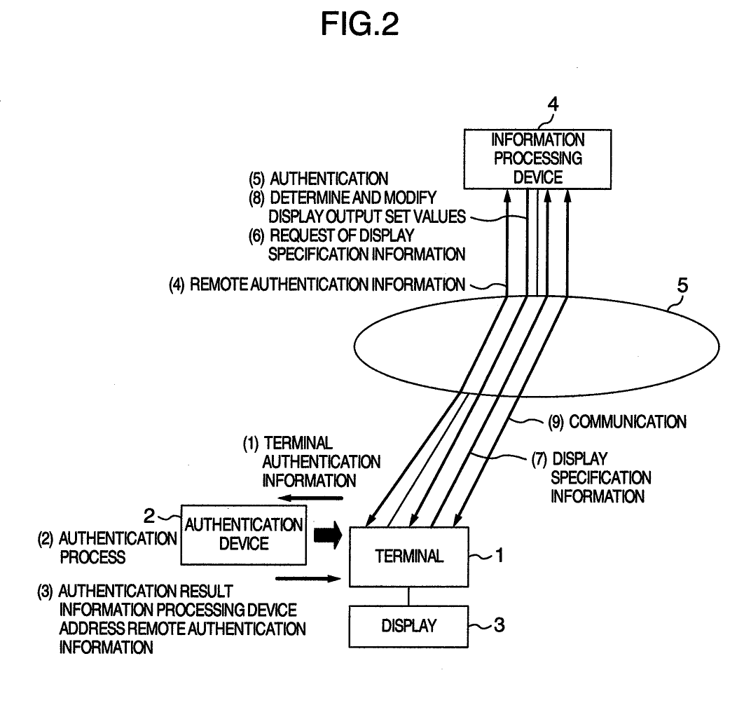

FIG. 2 is a diagram for explaining a summary of processing operation of the information processing system 1000. The authentication device 2 stores therein authentication information (which will be referred to as the terminal authentication information and the remote authentication information respectively, hereinafter) necessary for user authentication in the authentication device 2 and the information processing device 4 respectively and information about the IP address or the like of the information processing device 4 as a connection destination device to the terminal 1. The terminal 1 has a unit (which will be referred to as the display specification management table, hereinafter) for storing information (maximum resolution, inch size, etc.) about the specifications of the display device 3 connected to the terminal 1. The information processing device 4 has a unit (which will be referred to as the authentication information management table, hereinafter) for storing authentication information necessary for user, a unit (which will be referred to as the display output set value management table, hereinafter) for storing optimum display output set values (color, resolution) for a plurality of pieces of display specification information in association therewith, and a unit (which will be referred to as the display output set value file, hereinafter) for setting display output set values when the display information of the display device 3 is generated.

The user first inserts the authentication device 2 into a predetermined communication port (e.g., USB (Universal Serial Bus) port) provided to the terminal 1, and enters the terminal authentication information (e.g., user ID, password) in a predetermined input form displayed on the display device 3 with use of such an input unit such as a keyboard or mouse. The terminal 1 outputs the entered terminal authentication information to the authentication device 2 (1).

The authentication device 2 collates the terminal authentication information received from the terminal 1 with terminal authentication information (user ID, password) stored in the authentication device 2 for authentication (2), and outputs the IP address of the information processing device 4 as a connection target device to the terminal 1, profile information such as the IP address of the terminal 1, and remote authentication information (e.g., user ID, password) to the terminal 1 together with the authentication result (authentication establishment) (3).

The terminal 1 transmits the remote authentication information received from the authentication device 2 to the information processing device 4 via the network 5 (4).

The information processing device 4, when receiving the remote authentication information from the terminal 1 via the network 5, collates the received remote authentication information with the remote authentication information (e.g., user ID, password) stored in the information processing device 4 for authentication (5). After the authentication establishment, the information processing device 4 transmits a request of display specification information to the terminal 1 via the network 5 (6).

When receiving the display specification information request from the information processing device 4 via the network 5, the terminal 1 reads out the display specification information from the display specification information management table and transmits the read information to the information processing device 4 via the network 5 (7).

When receiving the display specification information from the terminal 1 via the network 5, the information processing device 4 determines display output set values suitable for the specifications of the display device 3 connected to the terminal 1 as a display specification information transmission originator on the basis of the received display specification information and display output set values for the specifications of each display device stored in the display output set value management table, and updates the display output set values stored in the display output set value file on the basis of the determined display output set values (8).

Thereafter, under control of a predetermined communication program (e.g., VPN (Virtual Private Network) communication program) stored in the terminal 1 and in the information processing device 4 respectively, a communication channel (e.g., VPN) is established between the terminal 1 and the information processing device 4, so that the terminal 1 can communicate with the information processing device 4 (9). That is, the terminal 1 transmits information (about the contents of operations of a keyboard and/or mouse) entered by the user to the information processing device 4 via the network 5. When receiving the input information from the terminal 1 via the network 5, the information processing device 4 generates display information (to be displayed on the desktop screen of the display device) with use of the received input information and display output set values stored in the display output set value file, and transmits the generated information to the terminal 1 via the network 5.

In this way, even a change in display device specifications is automatically reflected on display output set values suitable for the specifications of the display device as the display information. As a result, there can be provided a thin client type information processing system which can eliminate for the user to manually change the display output set values with a good handleability.

In some cases, an image displayed on the display device 3 may be against user's preference. Even in this case, the information processing device 4 has a function (OS standard function) of changing the display output set values set in the display output set value file to the display output set values specified by the user and also has a function of updating display output set values for the specifications of each display device stored in the display output set value management table on the basis of the changed display output set values. Thus, when the user uses the terminal 1 next time, a display image having the changed display output set values reflected thereon is automatically displayed on the display device 3.

Each of the devices shown in FIG. 1 will next be explained in detail.

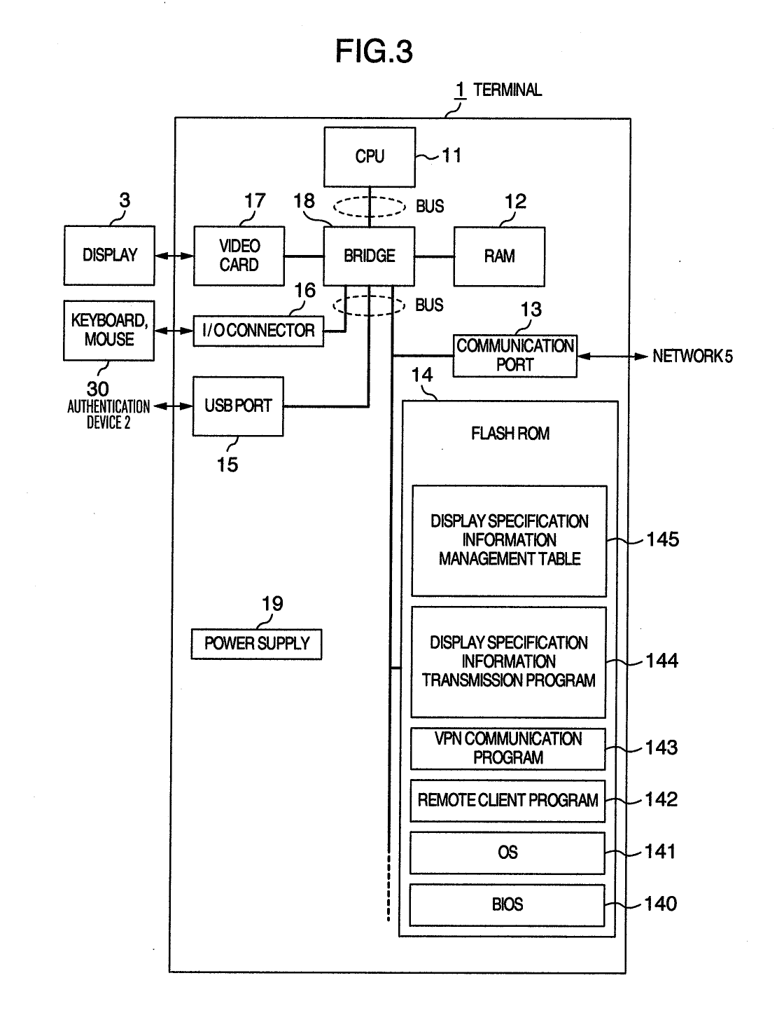

FIG. 3 shows an example of a schematic arrangement of the terminal 1.

The terminal 1 has a CPU (Central Processing Unit) 11, a RAM (Random Access Memory) 12 functioning as a work area for the CPU 11, a communication port 13 for transmitting or receiving information to or from the network 5, a flash ROM (Read Only Memory) 14, a USB port 15 for connection of the authentication device 2 thereto, an I/o connector 16 for connection of a keyboard or mouse 30 thereto, a video card 17 for connection of the display device 3 thereto, a bridge 18 for relaying internal connection lines such as a bus BUS to interconnect the constituent elements 11 to 17 by the bridge, and a power supply 19.

The flash ROM 14 stores therein at least a BIOS (Basic Input/Output System) 140, an OS 141, a remote client program 142, a VPN communication program 143, a display specification information transmission program 144, and a display specification information management table 145.

After the power supply 19 is turned ON, the CPU 11 first accesses the flash ROM 14 and executes the BIOS 140 to recognize the system configuration of the terminal 1.

The OS 141 is a program for causing the CPU 11 to generally control the respective components 12 to 19 of the terminal 1 and to execute the remote client program 142, the VPN communication program 143, and the display specification information transmission program 144. The CPU 11 loads the OS 141 from the flash ROM 14 into the RAM 12 and executes the OS under control of the BIOS 140. With it, the CPU 11 generally controls the respective components 12 to 19 of the terminal 1. As the OS 141 in the present embodiment, such a relatively small OS storable in the flash ROM 14 as an embedded type. OS is employed.

The remote client program 142 is used to receive a terminal service, that is, to cause the terminal 1 to access the desktop of the information processing device 4. The CPU 11 loads the remote client program 142 from the flash ROM 14 into the RAM 12 and executes the program according to the OS 141. With it, the CPU 11 transmits input information via the I/O connector 16 from the keyboard and/or mouse 30 to the information processing device 4 via the communication port 13 and the network 5, generates a display image on the basis of display differential information received from the information processing device 4 via the network 5, and outputs the generated image to the display device 3 connected to the video card 17.

The VPN communication program 143 is used to establish a communication channel with the information processing device 4. The CPU 11 loads the VPN communication program 143 from the flash ROM 14 into the RAM 12 and executes the program according to the OS 141.

The display specification information transmission program 144 has a function of receiving a request of display specification information from the information processing device 4 via the network 5 and the communication port 13, reads out the display specification information from the display specification information management table 145, and transmitting the read display specification information to the information processing device 4 from the communication port 13 via the network 5. The CPU 11 loads the display specification information transmission program 144 from the flash ROM 14 into the RAM 12 and executes the program under control of the OS 141.

The display specification information management table 145 previously stores specification information or the like about the display device 3.

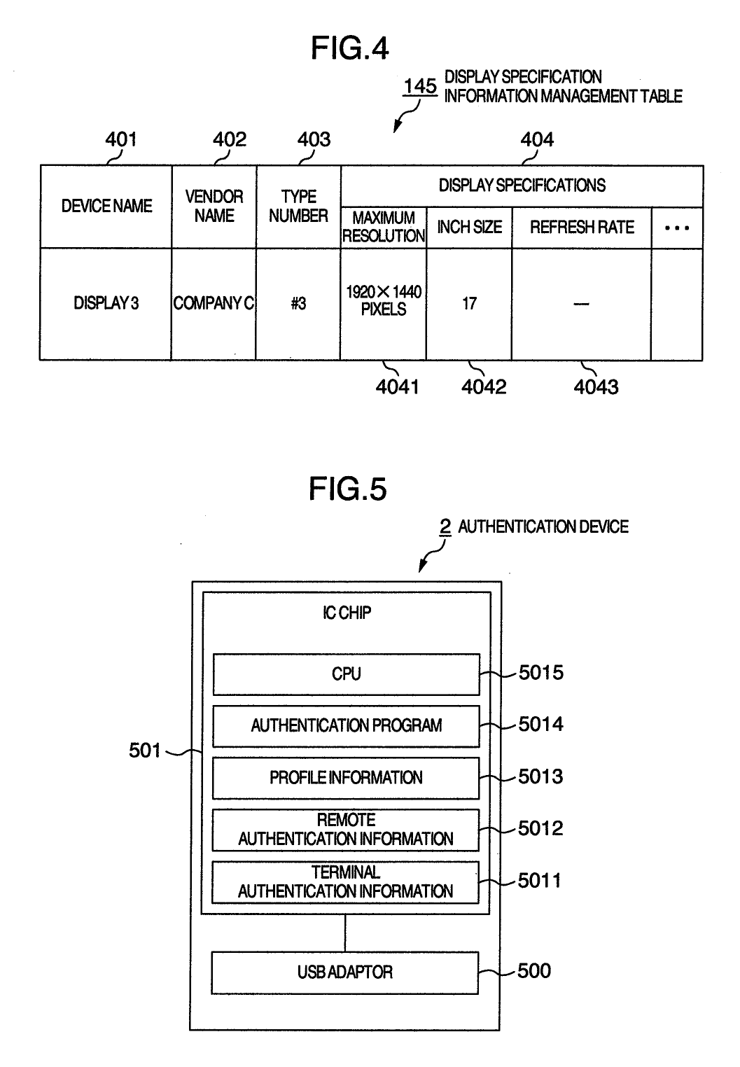

FIG. 4 shows an example of a schematic structure of the display specification information management table 145. Stored in the display specification information management table 145 are information about a device name 401, a vendor name 402, a product or type number 403, and a specification 404 to be associated with one another. The device name 401 is information for which the OS 141 manages information about the display device 3 connected to the terminal 1. The vendor name 402 is information indicative of the name of a vendor providing the display device 3. The type number 403 indicates the product number of the display device 3. The specification 404 is information about the specifications including a maximum resolution 4041, an inch size 4042, and a refresh rate 4043, which conform to the standard VESA (Video Electronics Standards Association) specifications. The refresh rate 4043 is required when the display device 3 is of a cathode-ray tube type, but is unnecessary when the display device 3 is of a liquid crystal type.

Explanation will then be made as to the authentication device 2. The authentication device 2 has a function of collating terminal authentication information received from the terminal 1 with terminal authentication information stored in the authentication device 2 for user's authentication, and informing the terminal 1 of its authentication result. The authentication device 2 also has a function of, when the authentication result is an authentication establishment, informing the terminal 1 of profile information (the IP address of the information processing device 4, the IP address of the terminal 1, etc.) and remote authentication information stored in the authentication device 2 together with the authentication result.

FIG. 5 shows an example of a schematic arrangement of the authentication device 2. The authentication device 2 has a USB adaptor 500 for connection to the USB port 15 of the terminal 1 and also has an IC chip 501.

The IC chip 501 has terminal authentication information 5011, remote authentication information 5012, profile information 5013, an authentication program 5014, and a CPU 5015 for executing the authentication program 5014. In this connection, a flash memory may be externally mounted to the authentication device 2 so that part of data within the IC chip 501 is stored in the flash memory.

The terminal authentication information 5011 is information (user ID, password) necessary for causing thee authentication device 2 to authenticate the user. The authentication program 5014 is used to collate the terminal authentication information (user ID, password) received from the terminal 1 with the terminal authentication information (user ID, password) 5011 stored in the authentication device 2 for user's authentication. The terminal authentication information 5011 is recorded by the user. With such an arrangement, even when a third person illegally gets the authentication device 2, the third person cannot be authenticated by the authentication program 5014, and thus cannot operate the terminal 1. The remote authentication information 5012 is information (user ID, password) required when the information processing device 4 authenticates the user. Since the same information as the above information is previously stored in the information processing device 4, the information processing device 4 can authenticate the user. With such an arrangement, illegal access of the third person to the information processing device 4 can be prevented.

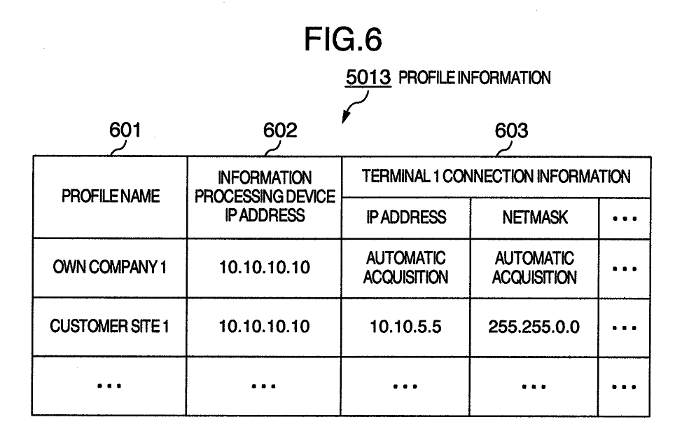

FIG. 6 shows an example of a schematic structure of the profile information 5013. The profile information 5013 includes information about a profile name 601, an IP address 602 of the information processing device 4 as a connection target to the terminal 1, and terminal 1 connection information 603 to be associated with one another. The profile information is recorded by the user.

Recorded in the profile name 601 is information, for example, of “one's own company 1” when the terminal 1 is connected to an in-company LAN, or information of “customer site 1” when the terminal 1 is connected to a network belonging to the customer site. The terminal 1 connection information 603 includes information relating to a network connection environment for use in each terminal 1, such as an IP address and a netmask. In the present embodiment, since the terminals 1 are shared by all the users, such an arrangement is made that network connection environment information of the terminals 1 are previously recorded in the authentication device 2 of each user, and each user carries the authentication device 2. In this way, since set information about communication is not stored in the terminal 1, a high security can be achieved.

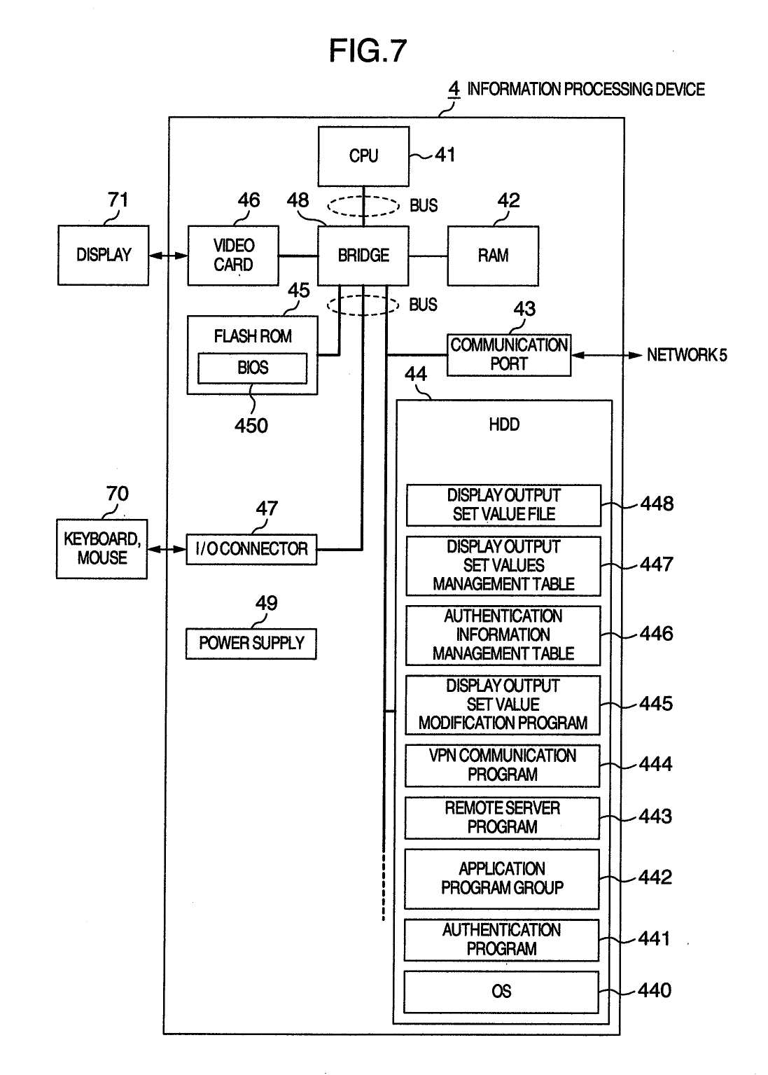

FIG. 7 shows an example of a schematic arrangement of the information processing device 4. The information processing device 4 has a CPU 41, a RAM 42 functioning as a work area of the CPU 41, a communication port 43 for receiving and transmitting information from and to the network 5, a HDD 44, a flash ROM 45, a video card 46 for connection with a display device 71, an I/O connector 47 for connection with a keyboard or mouse 70, a bridge 48 for relaying internal connection lines such as a bus BUS to connect the respective components 41 to 47, and a power supply 49. A BIOS 450 is stored in the flash ROM 45. After the power supply 49 is turned ON, the CPU 41 first accesses the flash ROM 45 and executes the BIOS 450 to recognize the system configuration of the information processing device 4.

Stored in the HDD 44 are at least an OS 440, an authentication program 441, a group of application programs 442, a remote server program 443, a VPN communication program 444, a display output set value modification program 445, an authentication information management table 446, a display output set values management table 447, and a display output set value file 448. The OS 440 is a program which causes the CPU 41 to generally control the respective constituent components 42 to 49 of the information processing device 4 and to execute the respective programs 441 to 445 to be explained layer. The CPU 41 loads the OS 440 from the HDD 44 into the RAM 42 and executes the OS 440 under control of the BIOS 450. As a result, the CPU 41 generally controls respective constituent components 42 to 49 of the information processing device 4.

The authentication program 441 has a function of collating the remote authentication information 5012 (see FIG. 5) received from the terminal 1 with remote authentication information stored in the authentication information management table 446 to authenticate the user. The CPU 41 loads the authentication program 441 from the HDD 44 to execute the program under control of the OS 440.

The application program group 442 includes programs of a general web browser, a word processor, a spreadsheet, etc. The CPU 41, in response to an instruction of the terminal 1 received via the remote server program 443 under control of the OS 440, loads a desired application program from the HDD 44 into the RAM 42 and executes the program. The executed result is transmitted to the terminal 1 via the communication port 43 and the network 5 under control of the remote server program 443.

The remote server program 443 is used to remotely operate the desktop of the information processing device 4 from the terminal 1 in order to provide a terminal service. The CPU 41 loads the remote server program 443 from the HDD 44 into the RAM 42 and executes the program under control of the OS 440. With it, the CPU 41 generates display information in the video card 46 on the basis of input information received from the terminal 1 via the network 5 and the communication port 43 and display output set values set in the display output set value file 448, extracts difference information from the previous display under control of the remote server program 443, and transmits to the terminal 1 via the communication port 43 and the network 5.

The VPN communication program 444 is used to establish a communication channel with the terminal 1. The CPU 41 loads the VPN communication program 444 from the HDD 44 into the RAM 12 and executes the program under control of the OS 440.

The display output set value modification program 445 has a function of determining display output set values suitable for the specifications of a display device connected to the terminal 1 as the transmission target of the display specification information on the basis of the display specification information 404 received from the terminal 1 via the network 5 and the communication port 43 and display output set values for the specifications of display devices stored in the display output set values management table 447, and a function of updating the display output set values set in the display output set value file 448 on the basis of the determined display output set values. The display output set value modification program 445 also has a function of monitoring the display output set values set in the display output set value file 448 at fixed intervals and, when detecting that the monitored display output set values were changed to the display output set values specified by the user, and a function of updating the display output set values of the display device stored in the display output set values management table 447 to the changed display output set values. The CPU 41 loads the display output set value modification program 445 from the HDD 44 into the RAM 42 and executes the program under control of the OS 440.

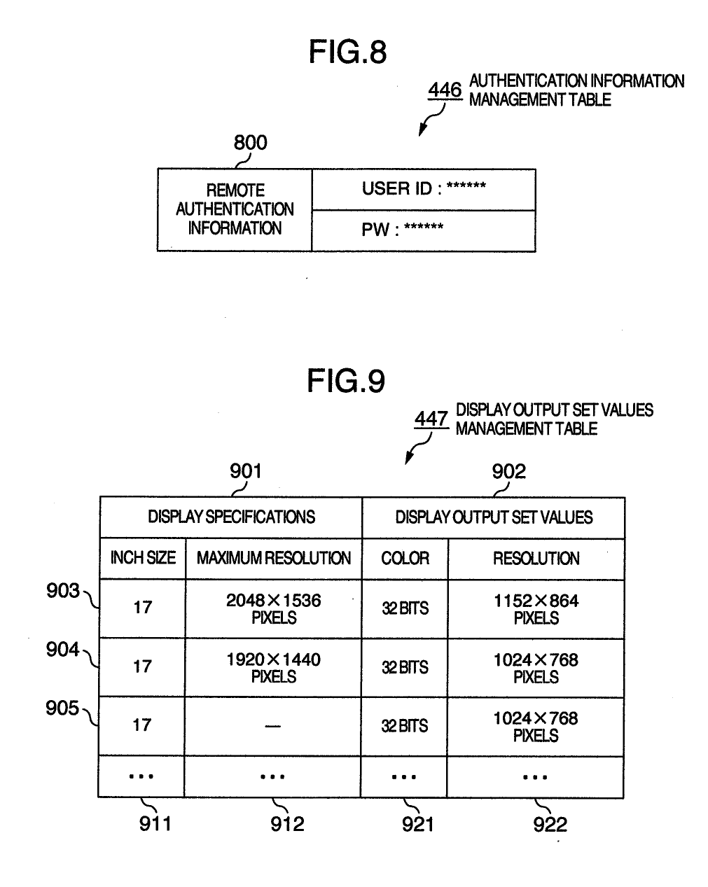

The respective structures of the authentication information management table 446, the display output set values management table 447, and the display output set value file 448 will be explained by referring to FIGS. 8, 9 and 10.

FIG. 8 shows an example of a schematic structure of the authentication information management table 446. Recorded in the authentication information management table 446 is remote authentication information (user ID, password) 800 to be used when the authentication program 441 authenticates the user of the terminal 1 as the terminal service providing party of the information processing device 4.

FIG. 9 shows an example of a schematic structure of the display output set values management table 447. The table 447 is used when the display output set value modification program 445 determines display output set values suitable for the specifications of the display device 3 connected to the terminal 1. As illustrated, a plurality of records are given in the display output set values management table 447. Stored in the records are information indicative of display specifications 901 and display output set values 902 suitable for the specifications 901 of the display device to be associated with one another. The display specifications 901 indicate the specifications of the display device 3, connected to the terminal 1, including an inch size 911 and a maximum resolution 912. The display output set values 902 indicate display output set values of the display specifications 901 of each display device such as a color 921 and a resolution 922. For example, display output set values optimum for an inch size of “17” and a maximum resolution of “2048×1536 pixels” correspond to a color of “32 bits” and a resolution of “1152×864 pixels” (record 903). Display output set values for an inch size of “17” and a maximum resolution of “1920×1440 pixels” correspond to a color of “32 bits” and a resolution of “1024×768 pixels” (record 904). As shown by the records 903 and 904, even for the same inch size, fine setting can be attained by discriminating between display devices having different maximum resolutions to control the display device.

Also recorded in the display output set values management table 447 are typical display output set values conforming to each inch size 911 as default data. For example, in a record 905, typical display output set values for an inch size of “17” (the maximum resolution being not set yet) are recorded. The display output set value modification program 445 searches the display output set values management table 447 on the basis of the display specification information (inch size and maximum resolution) received via the communication port 43 and the network 5. When failing to find no corresponding record as its searched result, the display output set value modification program 445 searches the display output set values management table 447 on the basis of the inch size, and sets the acquired display output set values in the display output set value file 448. As a result, a display image reflecting display output set values unsuitable for the specifications of the display device 3 can be prevented from appearing on the display device 3 connected to the terminal 1.

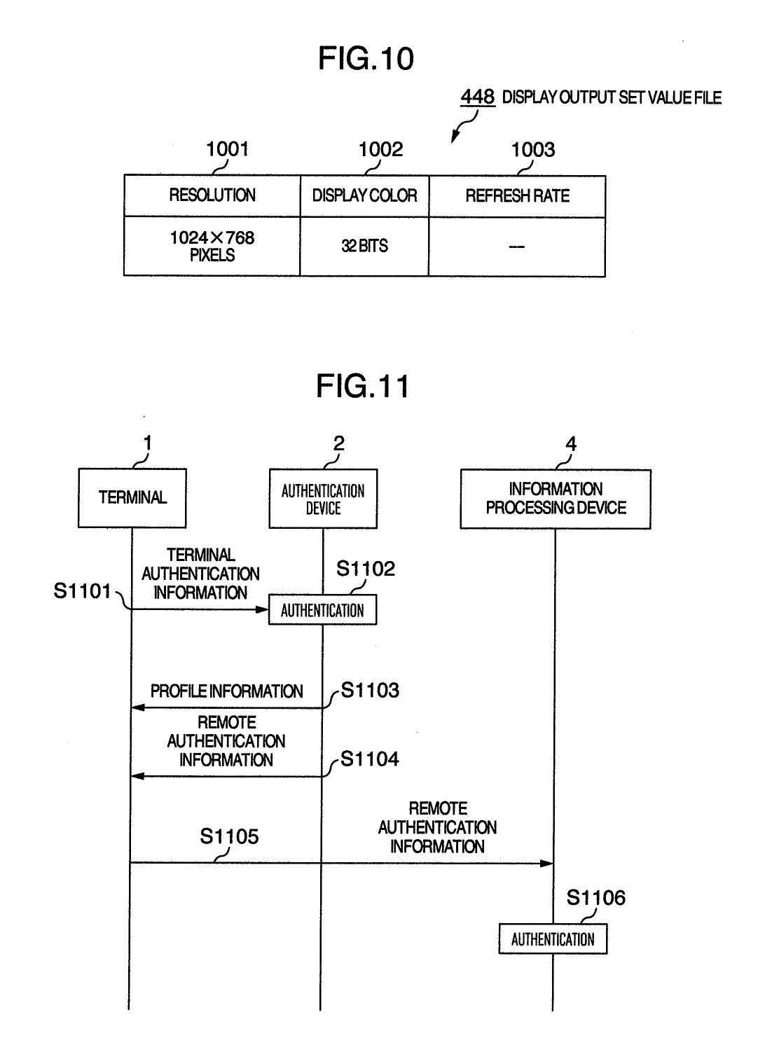

FIG. 10 shows an example of a schematic structure of the display output set value file 448. Set in the display output set value file 448 are display output set values determined by the display output set value modification program 445 or display output set values specified by the user. Recorded in the display output set value file 448 is information indicative of a resolution 1001, a display color 1002, and a refresh rate 1003 to be associated with one another. The refresh rate 1003 is required when the display device 3 is of a cathode-ray tube type, but is unnecessary when the display device 3 is of a liquid crystal type. Display output set values set in the display output set value file 448 are used when the remote server program 443 processes input information from the terminal 1 to generate display information.

FIGS. 11, 12 and 13 are diagrams showing the operation of the information processing system 1000. The processing operations shown by FIGS. 11, 12 and 13 are executed by the CPU under control of a program. It is assumed that the display device 3 connected to the terminal 1 is of a liquid crystal type.

When the authentication device 2 is first inserted into the USB port 15, the CPU 11 of the terminal 1 displays an input form for the terminal authentication information (user ID, password) on the display device 3 connected to the video card 17. The CPU 11 accepts the input terminal authentication information via the I/O connector 16, and outputs the accepted information to the authentication device 2 connected to the USB port 15 to ask the device to perform user authentication (step 1101).

The CPU 5015 of the authentication device 2 collates the terminal authentication information (user ID, password) accepted from the terminal 1 with terminal authentication information 5011 (user ID, password) stored in the authentication device 2 to perform user authentication under control of the authentication program 5014 (step 1102).

When its authentication result is an authentication failure, the CPU 5015 informs the terminal 1 of the authentication failure. The CPU 11 of the terminal 1, when receiving the above notification, performs such predetermined error handling as to display an error message on the display device 3.

When the result is authentication establishment in the step 1102, the CPU 5015 of the authentication device 2 transmits the profile information 5013 (see FIG. 6) and the remote authentication information (user ID, password) 5012 stored in the authentication device 2 to the terminal 1 (steps 1103 and 1104).

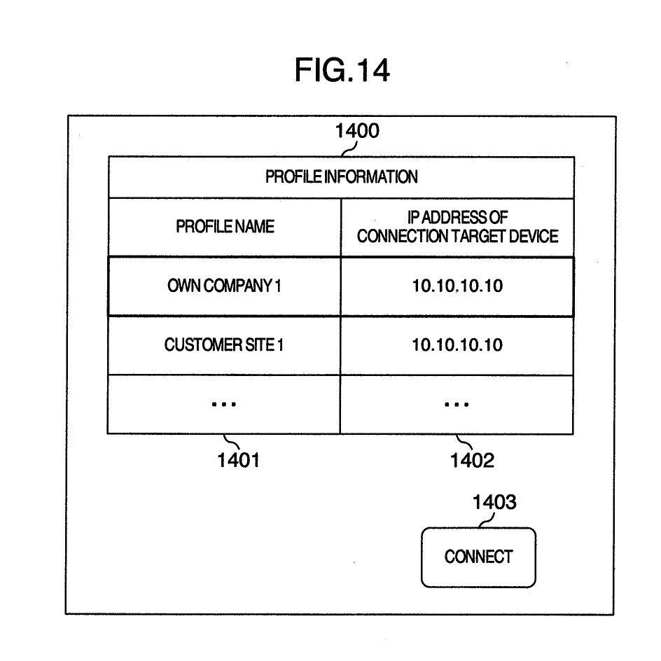

The CPU 11 of the terminal 1, when receiving these information displays, for example, such a profile information list 1400 as shown in FIG. 14 on the display device 3. When the user selects a profile name 1401 of “one's own company 1” and an IP address 1402 of the connection target device of “10.10.10.10” and clicks the mouse on a CONNECT button 1403, for example, using the keyboard and/or mouse 30 in the profile information list 1400 displayed on the display device 3; the CPU 11 transmits the remote authentication information (user ID, password) 5012 to the information processing device 4 having the IP address of “10.10.10.10” allocated thereto together with the IP address of the terminal 1 via the communication port 13 and the network 5 (step 1105).

When receiving the remote authentication information (user ID, password) 5012 via the network 5 and the communication port 43, the CPU 41 of the information processing device 4 collates the received remote authentication information (user ID, password) 5012 with the remote authentication information (user ID, password) 800 (see FIG. 8) stored in the authentication information management table 446 to perform user authentication (step 1106). After determining a user authentication establishment, the CPU 41 transmits a request of display specification information to the terminal 1 via the communication port 43 and the network 5 under control of the display output set value modification program 445. At this time, the CPU 41 monitors display output set values set in the display output set value file 448 at fixed intervals under control of the display output set value modification program 445 (step 1107).

When receiving the display specification information request from the information processing device 4 via the network 5 and the communication port 13, the CPU 11 of the terminal 1 reads out the display specification information 404 from the display specification information management table 145 (see FIG. 4), and transmits the read information to the information processing device 4 via the communication port 13 and the network 5 under control of the display specification information transmission program 144 (step 1108).

The CPU 41 of the information processing device 4, when receiving the display specification information from the terminal 1 via the network 5 and the communication port 43, stores the received display specification information in a predetermined storage area of the RAM 42 under control of the display output set value modification program 445 (step 1109). The CPU 41 also determines display output set values suitable for the specifications of the display device 3 connected to the terminal 1 on the basis of the display specification information and display output set value information per each display specification stored in the display output set values management table 447 under control of the display output set value modification program 445 (step 1110). The CPU then updates display output set values set in the display output set value file 448 on the basis of the determined display output set values under control of the display output set value modification program 445 (step 1111).

Thereafter, under control of the VPN communication programs 143 and 444 stored in the terminal 1 and the information processing device 4 respectively, a communication path or channel is established between the terminal 1 and the information processing device 4 (step 1112).

The CPU 11 of the terminal 1 transmits information entered by the user from the keyboard and/or mouse 30 to the information processing device 4 via the communication port 13 and the network 5 under control of the remote client program 142 (step 1113).

The CPU 41 of the information processing device 4, when receiving the input information from the terminal 1 via the network 5 and the communication port 43, generates display information in the video card 46 using the input information and using display output set values set in the display output set value file 448, generates a difference from the display information under control of the remote server program 443, and transmits the difference information to the terminal 1 via the communication port 43 and the network 5. The CPU 11 of the terminal 1, when receiving the display difference information from the information processing device 4 via the network 5 and the communication port 13, reconstructs a display image under control of the remote client program 142, and displays the reconstructed image on the display device 3 connected to the terminal 1 (step 1114). Thereafter, the repetitive operations of the steps 1113 and 1114 cause a terminal service to be provided, so that the user remotely can control the information processing device 4 from the terminal 1.

Thereafter, when the user wants to modify the display output set values set by the information processing device 4, the display output set values set in the display output set value file 448 can be modified to display output set values specified by the user by utilizing the standard function of the OS 440 stored in the information processing device 4, as in the prior art. A procedure of modifying display output set values based on the user of the standard function of the OS 440 will be explained in connection with steps 1115 to 1119.

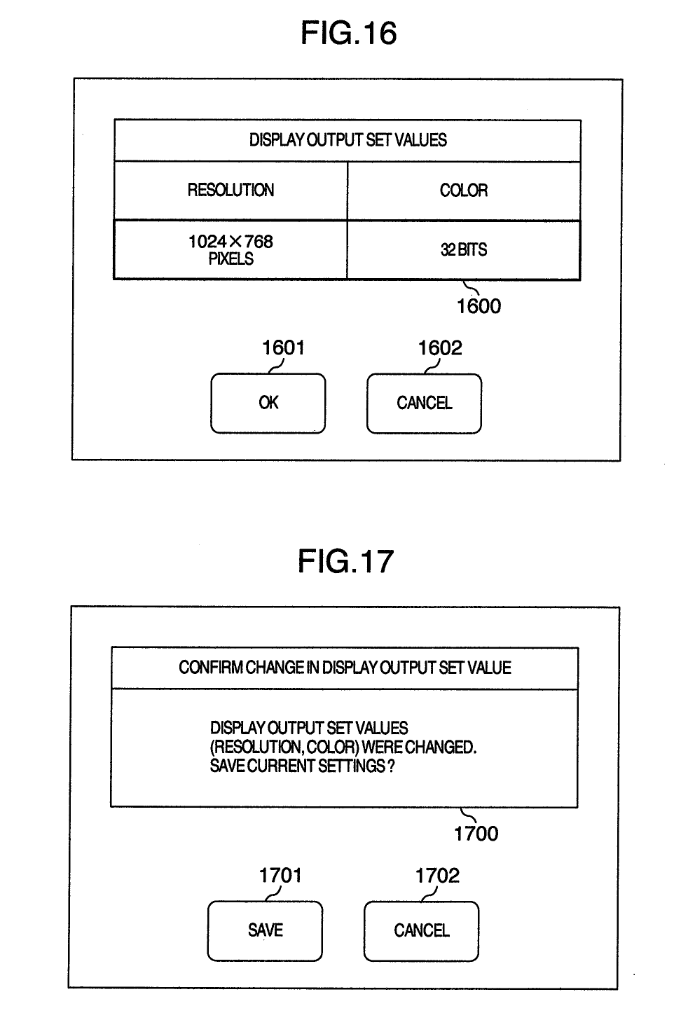

FIG. 16 shows an example of a display screen when display output set values are modified. When the user specifies display output set values (e.g., a resolution of “1024×768 pixels”, a color of “32 bits”) 1600 using the keyboard and/or mouse 30 and clicks the mouse on an OK button 1601; the CPU 11 of the terminal 1 transmits the display output set values to the information processing device 4 via the communication port 13 and the network 5 (step 1115).

When receiving the display output set values specified by the user from the terminal 1 via the network 5 and the communication port 43, the CPU 41 of the information processing device 4 generates a screen (see FIG. 17) for confirming the modified set values reflecting the received display output set values, and transmits the generated information to the terminal 1 via the communication port 43 and the network 5 (step 1116).

The CPU 11 of the terminal 1 displays a message indicative of confirmation of the changed set values from the information processing device 4 via the network 5 and the communication port 13 on the display device 3 (step 1117). When the user confirms the acceptance or non-acceptance of the modified display output set values on the display screen and clicks on a SAVE button 1701 using the keyboard and/or mouse 30, the CPU 11 transmits a SAVE request to the information processing device 4 via the communication port 13 and the network 5 to save the display output set values (step 1118).

When receiving the SAVE request of the display output set values from the terminal 1 via the network 5 and the communication port 43, the CPU 41 of the information processing device 4 modifies the display output set values set in the display output set value file 448 to the display output set values specified by the user (step 1119).

As mentioned above, the CPU 41, after the step 1107, monitors the display output set values set in the display output set value file 448 at fixed intervals under control of the display output set value modification program 445, detects a change in the display output set values in the step 1119, reads out display specification information from a predetermined memory area of the RAM 42 under control of the display output set value modification program 445, searches the display output set values management table 447 (see FIG. 9) on the basis of the read-out display specification information, and modifies the display output set values 902 of the corresponding record to the display output set values specified by the user (step 1120).

In the display output set value modification screen (see FIG. 16), when the user clicks the mouse on a CANCEL button 1602 using the keyboard and/or mouse 30, the CPU 11 of the terminal 1 transmits information indicative of cancellation to the information processing device 4 via the communication port 13 and the network 5. The CPU 41 of the information processing device 4, when receiving the cancellation information from the terminal 1 via the network 5 and the communication port 43, terminates its processing operation. When the user fails to select any of the OK button 1601 and the CANCEL button 1602 even after passage of a predetermined time, the CPU 41 also terminates its processing operation.

In the set value modification confirmation screen (see FIG. 17), when the user clicks the mouse on a CANCEL button 1702 using the keyboard and/or mouse 30, the CPU 11 of the terminal 1 transmits information indicative of cancellation to the information processing device 4 via the communication port 13 and the network 5. The CPU 41 of the information processing device 4, when receiving the cancellation information from the terminal 1 via the network 5 and the communication port 43, terminates its processing operation without updating the set contents of the display output set value file 448. When the user fails to select any of the SAVE button 1701 and the CANCEL button 1702 even after passage of a predetermined time, the CPU 41 also terminates its processing operation without updating the display output set values set in the display output set value file 448.

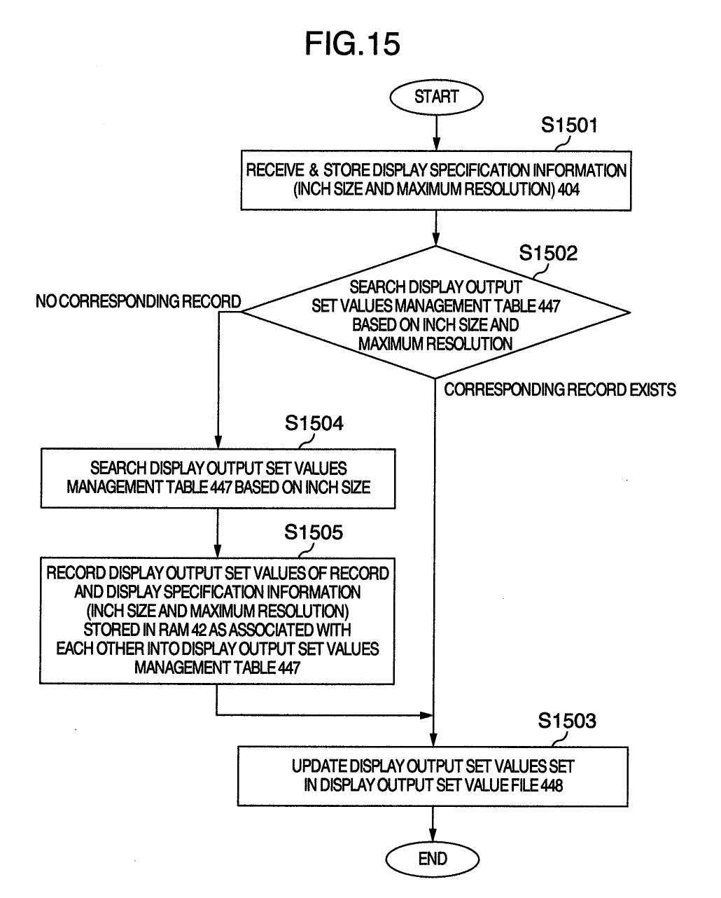

FIG. 15 is a flow chart showing the processing operation of the display output set value modification program 445 when determining display output set values on the basis of display specification information from the terminal 1 and information stored in the display output set values management table 447 and updating the display output set values set in the display output set value file 448.

The CPU 41 of the information processing device 4, when receiving display specification information (inch size and maximum resolution) from the terminal 1 via the network 5 and the communication port 43, stores the received display specification information in a predetermined memory area of the RAM 42 (step 1501). Next, the CPU 41 searches the display output set values management table 447 on the basis of the inch size and the maximum resolution (step 1502). When finding the corresponding record as the researched result, the CPU 41 reads out display output set values (color and resolution) from the record, and changes the set contents of the display output set value file 448 to the read-out display output set values (step 1503).

When failing to find the corresponding record in the step 1502, the CPU 41 of the information processing device 4 searches the display output set values management table 447 on the basis of the inch size (step 1504), and records the display output set values (default data) of the corresponding record and the display specification information (inch size and maximum resolution) stored in the RAM 42 in the display output set values management table 447 to be associated with each other (step 1505). The CPU 41 also changes the set contents of the display output set value file 448 to the aforementioned display output set values (default data) (step 1503).

When failing to find the corresponding record in the step 1502, the CPU 41 may execute the operation of the step 1505, after the processing operation of the step 1503 after the processing operation of the step 1504.

The first embodiment of the present invention has been explained above.

### Embodiment 2

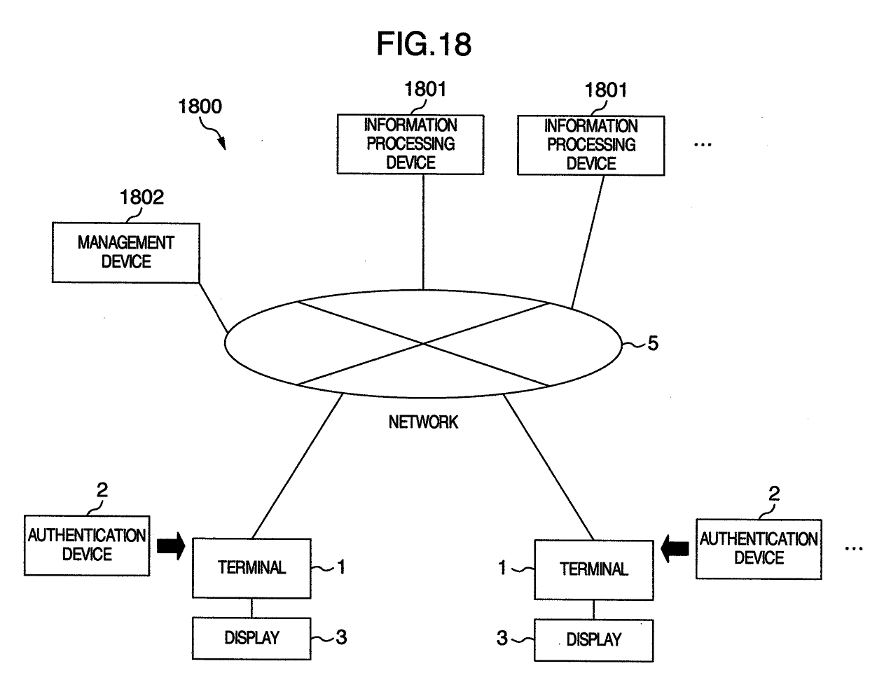

FIG. 18 shows an example of a schematic configuration of an information processing system in accordance with a second embodiment of the present invention.

An information processing system 1800 in accordance with the present embodiment, which is of a point-to-blade connection and display transmission type, includes a plurality of terminals 1, a plurality of authentication devices 2, a plurality of information processing devices 1801, and a management device 1802. Each of the display devices 3 is connected to each of the terminal 1. The terminals 1, information processing devices 1801, and the management device 1802 are connected to such a network 5 as a LAN.

The present embodiment is different in system configuration from the first embodiment in that the information processing device 1801 is of a blade type which can be integrated in the form of several processors as a unit in such a device as a rack and that the management device 1802 is newly added. The management device 1802 is combinedly installed in a computer center or the like for centralized control.

The internal structure of the information processing device 1801 is similar to that of the information processing device 4.

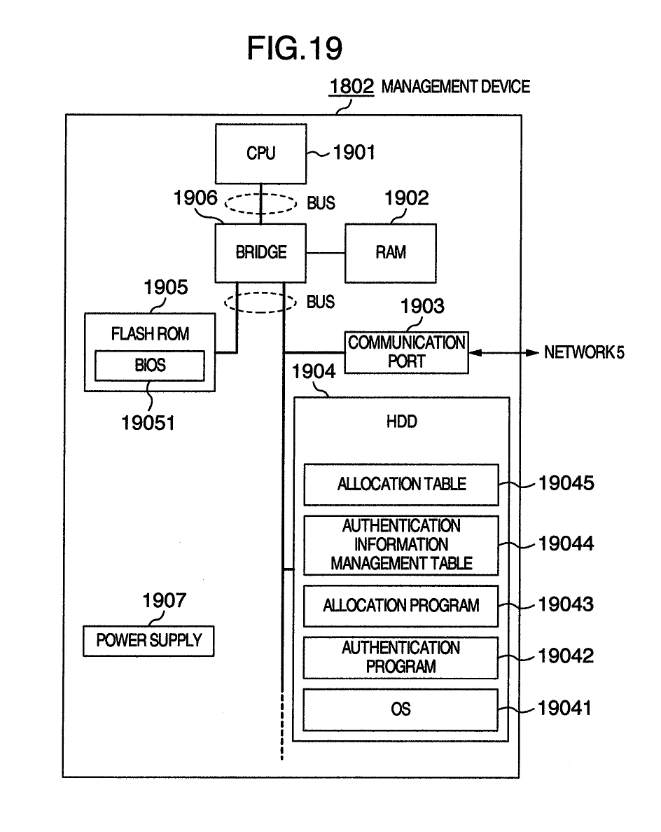

FIG. 19 shows an example of a schematic structure of the management device 1802. The management device 1802 has a CPU 1901, a RAM 1902 functioning as a work area of the CPU 1901, a communication port 1903 for receiving and transmitting information from and to the network 5, a HDD 1904, a flash ROM 1905, a bridge 1906 for relaying an internal connection line such as a bus BUS to connect these constituent components 1901 to 1905, and a power supply 1907.

A BIOS 19051 is stored in the flash ROM 1905. The CPU 1901 recognizes the system configuration of the management device 1802 by first accessing the flash ROM 1905 after the power supply 1907 is turned ON and executing the BIOS 19051.

Stored in the HDD 1904 are at least an OS 19041, an authentication program 19042, an allocation program 19043, an authentication information management table 19044, and an allocation management table 19045.

Under control of an OS 19041, the CPU 1901 generally controls the respective constituent components 1902 to 1907 of the management device 1802 to execute the authentication program 19042 and the allocation program 19043. The CPU 1901 loads the OS 19041 from the HDD 1904 into the RAM 1902 and executes the OS under control of the BIOS 19051. As a result, the CPU 1901 generally control the respective constituent components 1902 to 1907 of the management device 1802.

The authentication program 19042 has a function of collating remote authentication information (user ID, password) received from the terminal 1 via the network 5 and the communication port 1903 with remote authentication information (user ID, password) stored in the authentication information management table 19044 for user's authentication. The CPU 1901 loads the authentication program 19042 from the HDD 1904 and executes the program under control of the OS 19041.

The allocation program 19043 has a function of, after the authentication operation (authentication establishment) of the authentication program 19042, reading out the IP address of the information processing device 1801 for the user to allocate from the allocation management table 19045 and informing the terminal 1 of the read-out IP address via the network 5. The CPU 1901 loads the allocation program 19043 from the HDD 1904 and executes the program under control of the OS 19041.

Recorded in the authentication information management table 19044 are remote authentication information (user ID, password) for a plurality of users.

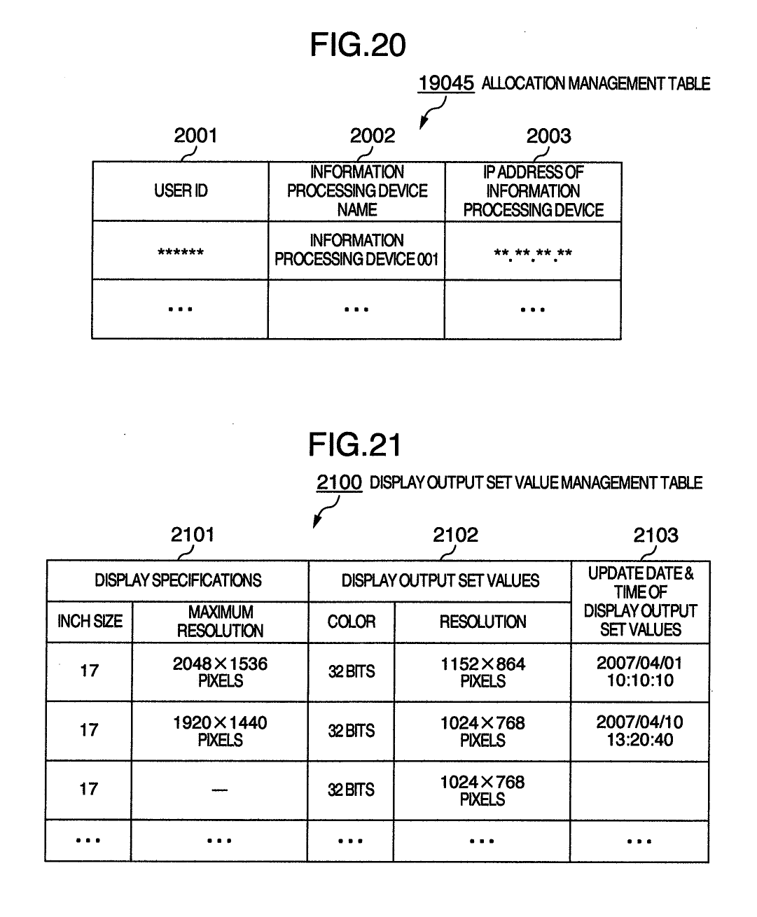

As shown in FIG. 20, information about a user ID 2001, an information processing device name 2002, and an IP address 2003 of the information processing device as the connection target device to the terminal 1 are recorded to be associated with one another in the allocation management table 19045.

Explanation will be made as to processing parts of the present embodiment different from the first embodiment by referring to FIG. 11 (first embodiment). After the operations of the steps 1101 to 1102, the CPU 11 of the terminal 1 receives such profile information as the IP address of the management server 1802 or the IP address of the terminal 1 and remote authentication information (user ID, password). The CPU 11 then transmits the remote authentication information (user ID, password) together with the IP address of the terminal 1 to the management device 1802 via the communication port 13 and the network 5.

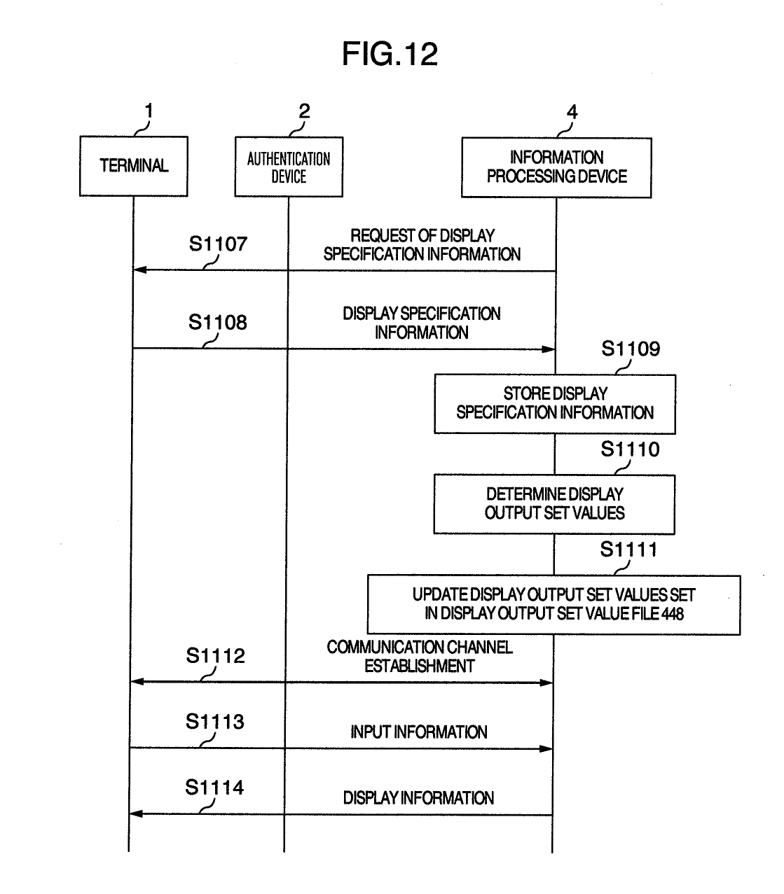

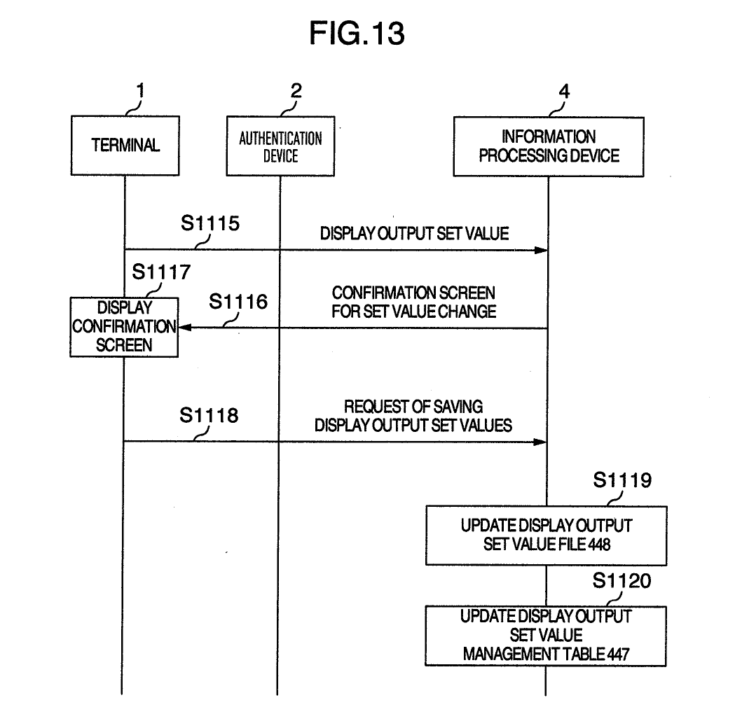

The CPU 1901 of the management device 1802 collates the remote authentication information (user ID, password) received from the terminal 1 via the network 5 and the communication port 1903 with remote authentication information (user ID, password) for the user stored in the authentication information management table 19044 for user's authentication. After the authentication establishment, the CPU 1901 searches the allocation management table 19045 (see FIG. 20) on the basis of he user ID and reads out the IP address of the information processing device 1801 as the connection target device to the terminal 1 from the searched record. The CPU 1901 then informs the information processing device 1801 having the IP address allocated thereto of the IP address of the terminal 1 as the remote authentication information transmission originator via the communication port 1903 and the network 5. The subsequent processing operations are similar to those shown in FIGS. 12 and 13.

### Embodiment 3

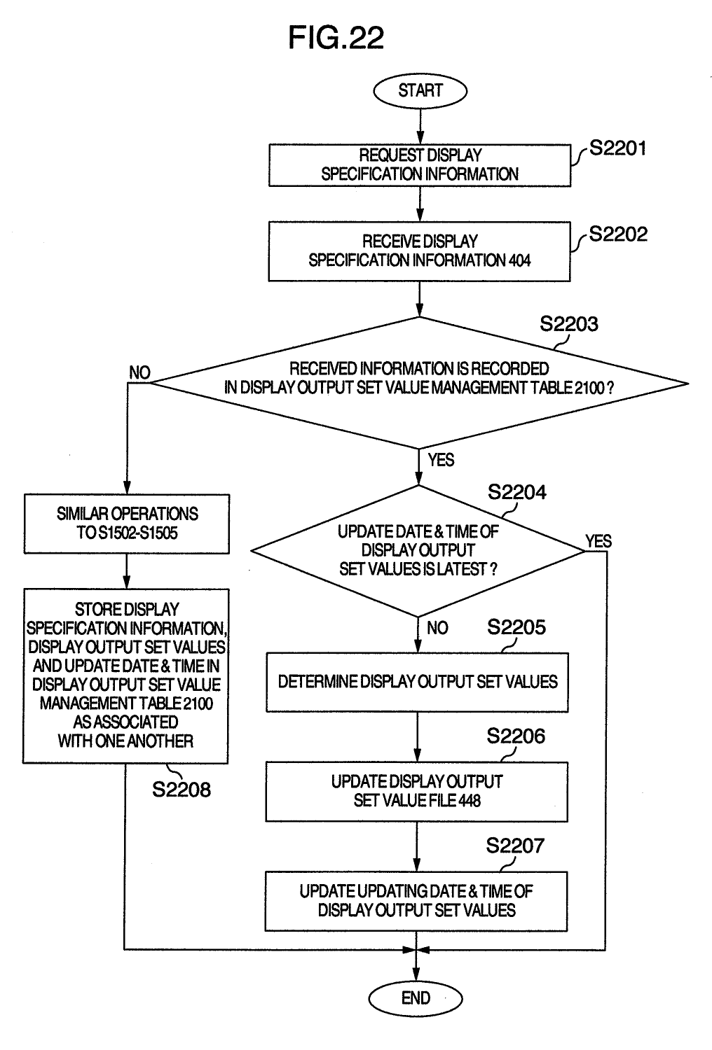

The present embodiment is different from the first embodiment in that such a display output set value management table 2100 as shown in FIG. 21 is stored in the HDD 44 of the information processing device 4 in the first embodiment. The present embodiment is also different from the first embodiment in that the display output set value modification program 445 (see FIG. 7) executes operations which will be explained later (see FIG. 22). Explanation will be made as to the display output set value management table 2100 and the operation of the display output set value modification program in the present embodiment by referring to FIGS. 21 and 22.

FIG. 21 shows an example of a schematic structure of the display output set value management table 2100. The table 2100 has a plurality of records. Recorded in respective records of the display output set value management table 2100 are information about display device specifications 2101, display output set values 2102, a display output set-value update date & time 2103 to be associated with one another. The display device specifications 2101 and the display output set values 2102 are the same as the display specifications 901 and the display output set values 902 in the display output set values management table 447 (see FIG. 9) in the first embodiment respectively. The display output set-value update date & time 2103 indicates a date and time when display output set values set in the display output set value file 448 (see FIG. 10) are updated.

FIG. 22 is a flow chart showing the operation of the display output set values modification program in the present embodiment. For simplicity of explanation, explanation will be made merely on the assumption that the operations of steps of the flow chart are executed by a CPU as an execution entity as in the first embodiment.

The CPU 41 of the information processing device 4 transmits a request of display specification information to the terminal 1 via the communication port 43 and the network 5 (step 2201). The CPU 11 of the terminal 1, when receiving the request of display specification information from the information processing device 4 via the network 5 and the communication port 13, reads out the display specification information 404 from the display specification information management table 145 (see FIG. 4), and transmits the read-out information to the information processing device 4 via the communication port 13 and the network 5. The CPU 41 of the information processing device 4 receives the display specification information 404 from the terminal 1 via the network 5 and the communication port 43 (step 2202). The CPU 41 then stores the display specification information in a predetermined memory area of the RAM 42. As has been explained in the first embodiment, the display specification information stored in the RAM 42 is used when display output set values set in the display output set value file 448 are modified to the display output set values specified by the user. Next, the CPU 41, by referring to the display output set value management table 2100, determines whether or not the received display specification information is recorded in the display output set value management table 2100 (step 2203). When the received display specification information is recorded in the display output set value management table 2100 as the determined result, the CPU 41 refers to the display output set-value update date & time 2103 for all records of the display output set value management table 2100, and determines whether or not the corresponding display output set-value update date & time of the display specification information received in the step 2202 is the latest (step 2204). When the display output set-value update date & time is the latest as the determined result, the CPU 41 terminates its operation. In this case, a desktop screen reflecting the display output set values set in the display output set value file 448 appears on the terminal 1.

When the display output set value update date & time is not the latest as the determined result in the step 2204, the CPU 41 determines display output set values suitable for the specification of the display device 3 connected to the terminal 1 on the basis of the received display specification information and display output set value information of the display devices stored in the display output set value management table 2100 (step 2205), and updates the display output set values set in the display output set value file 448 based on the determined display output set values (step 2206). The CPU 41 then updates the display output set-value update date & time 2103 of the display output set value management table 2100 (step 2207).

When the received display specification information is not recorded in the display output set value management table 2100 as the determined result in the step 2203, the CPU 41 performs similar operations to the operations of the steps 1502 to 1505 (see FIG. 15). After the operation of the step 1505, the CPU 41 stores the received display specification information, the display output set values updated in the step 1503, and the corresponding display output set value update date & time in the display output set value management table 2100 to be associated with one another (step 2208).

### Embodiment 4

The present embodiment is different from the second embodiment in that the display output set value management table 2100 shown in FIG. 21 is stored in the HDD of the information processing device 1801 in the second embodiment. The operation of the display output set value modification program 445 (see FIG. 7) is the same as the operation shown in FIG. 22.

### Embodiment 5

In the foregoing third and fourth embodiments, the update date and time of display output set values acquired by the display output set value modification program has been managed by the display output set value management table 2100. Alternatively, such an arrangement may be made that, for example, the VPN communication program acquires information about the communication end date and time and the information is managed by the display output set value management table 2100.

The embodiments of the present invention have been explained in the foregoing. In accordance with the first to fifth embodiments of the present invention, in the thin client type of the information processing system, even when the display specifications are changed, there can be provide a technique for automatically set display output set values suitable for the specifications of the changed display device. As a result, there can be provided a thin client type of information processing system which eliminates the need for a user to manually change display output set values and have a good handleability.

In accordance with the third to fifth embodiments of the present invention, when a terminal which is accessed by an information processing device was also accessed by the same information processing device immediately before the access, the operation speed of the system can be increased because the information processing device can eliminate the need of the operations of the steps 1502 to 1505 (see FIG. 15) explained in the first and second embodiments.

It should be further understood by those skilled in the art that although the foregoing description has been made on embodiments of the invention, the invention is not limited thereto and various changes and modifications may be made without departing from the spirit of the invention and the scope of the appended claims.

1. A display output setting method carried out in an information processing device connected with a plurality of terminals via a network, comprising the steps of:
receiving an authentication request including authentication information from at least one terminal, as an authentication request transmission organizer, of the plurality of terminals via the network;
collating the received authentication information with authentication information stored in a memory for authentication;
transmitting a request of specification information of a display device connected to the terminal to the terminal via the network when the authentication is satisfied as a result of the authentication;
receiving the specification information of the display device connected to the terminal from the terminal via the network;
determining a display output set value of the display device from the terminal based on the specification information of the display device and the display output set value of the display device for each specification;
storing the determined display output set value in the memory;
receiving input information of the terminal via the network;
generating display information to be displayed on the display device of the terminal based on the input information and the display output set value stored in the memory; and
transmitting the display information to the terminal as the authentication request transmission originator via the network.

2. The display output setting method according to claim 1, further comprising the steps of:
receiving the specification information of the display device connected to the terminal from the terminal via the network;
determining whether or not the specification information of the display device is stored in the memory after the receiving step;
referring to update date and time information of the display output set value of the display device for each specification stored in the memory when the specification information of the display device is stored in the memory as a result of the determination;
determining the display output set value of the display device from the terminal based on the received specification information of the display device and the display output set value of the display device for each specification stored in the memory when update date and time associated with the received specification information of the display device is not the latest;
storing the determined display output set value in the memory;
generating display information to be displayed on the display device of the terminal based on the input information of the terminal and the display output set value stored in the memory; and
transmitting the generated display information via the network to the terminal.

3. The display output setting method according to claim 1, wherein, after the display information is transmitted to the terminal via the network, the display output set value stored in the memory is modified to a display output set value specified by a user.

4. The display output setting method according to claim 2, wherein, when the determined display output set value is stored in the memory, the update date and time information of the display output set value stored in the memory is updated.

5. The display output setting method according to claim 1, further comprising the steps of:
receiving the specification information connected to the terminal from the terminal via the network;
determining whether or not the specification information of the display device is stored in the memory after the receiving step;
determining the display output set value of the display device based on communication end date information of the display output set value of the display device for each specification stored in the memory when the specification information of the display device is stored in the memory as a result of the determination, or based on the received specification information of the display device and the display output set value of the display device for each specification stored in the memory when the communication end date associated with the received specification information of the display device is not the latest;
storing the determined display output set value in the memory;
generating display information to be displayed on the display device of the terminal based on the input information of the terminal and the display output set value stored in the memory; and
transmitting the generated display information via the network to the terminal.

6. An information processing device connected to a plurality of terminals via a network, comprising:
a transceiver which transmits or receives information to or from at least one terminal, as an authentication request transmission originator, of the plurality of terminals via the network;
a memory which stores a display output set value of a display device for each specification connected to the terminal; and
a controller which receives an authentication request including authentication information from the terminal via the network, collates the received authentication information with authentication information stored in the memory for authentication, transmits a request of the specification information of the display device connected to the terminal via the network to the terminal as an authentication request transmission originator when the authentication is satisfied as a result of the authentication, receives the specification information of the display device connected to the terminal from the terminal via the network, determines the display output set value of the display device from the terminal based on the specification information of the display device and the display output set value of the display device for each specification stored in the memory, stores the determined display output set value in the memory, receives the input information of the terminal via the network, generating display information to be displayed on the display device of the terminal based on the input information and the display output set value stored in the memory, and transmits the display information via the network to the terminal.

7. The information processing device according to claim 6, wherein the controller receives the specification information of the display device connected to the terminal from the terminal via the network, determines whether or not the specification information of the display device is stored in the memory after the reception of the specification information, refers to update date and time information of the display output set value of the display device for each specification stored in the memory when the specification information of the display device is stored in the memory as a result of the determination, determines the display output set value of the display device from the terminal based on the received specification information of the display device and the display output set value of the display device for each specification stored in the memory when update date and time associated with the received specification information of the display device is not the latest, stores the determined display output set value in the memory, generates display information to be displayed on the display device of the terminal based on the input information of the terminal and the display output set value stored in the memory, and transmits the generated display information via the network to the terminal.

8. The information processing device according to claim 6, wherein the controller transmits the display information via the network to the terminal, and modifies the display output set value stored in the memory to a display output set value specified by a user after transmission of the display information.

9. The information processing device according to claim 7, wherein, when the determined display output set value is stored in the memory, the controller updates the update date and time information of the display output set value stored in the memory.

10. The information processing device according to claim 6, wherein the controller receives the specification information of the display device connected to the terminal via the network from the terminal, determines whether or not the specification information of the display device is stored in the memory after reception of the specification information, determines a display output set value of the display device from the terminal based on communication end date information of the display output set value of the display device for each specification stored in the memory when the specification information of the display device is stored in the memory as a result of the determination, or based on the received specification information of the display device and the display output set value of the display device for each specification stored in the memory when a communication end date associated with the received specification information of the display device is not the latest, stores the determined display output set value in the memory, generates a display information to be displayed on the display device of the terminal based on the input information of the terminal and the display output set value stored in the memory, and transmits the generated display information via the network to the terminal.

11. An information processing system including:
a plurality of terminals; and
an information processing device connected with the plurality of terminals via a network,
wherein each of the terminals comprising:
a transceiver which transmits or receives information to or from the information processing device via the network;
a memory which stores specification information of a display device connected to each of the terminals; and
a controller which reads out the specification information of the display device connected to the memory when receiving a request of the specification information of the display device via the network from the information processing device, and transmits the information to the information processing device via the network, and
wherein the information processing device comprising:
a transceiver which transmits or receives information to or from each of the terminals via the network;
a memory which stores a display output set value of the display device for each specification connected to each of the terminals; and
a controller which receives an authentication request including authentication information from at least one terminal, as an authentication request transmission organizer, of the plurality of terminals via the network, collates the received authentication information with authentication information stored in the memory for authentication, transmits the request of the specification information of the display device connected to the terminal via the network to the terminal when the authentication is satisfied as a result of the authentication, receives the specification information of the display device connected to the terminal from the terminal via the network, determines a display output set value of the display device from the terminal based on the specification information of the display device and the display output set value of the display device for each specification stored in the memory, stores the determined display output set value in the memory, receives input information of the terminal via the network, generates display information to be displayed on the display device of the terminal based on the input information and the display output set value stored in the memory, and transmits the display information via the network to the terminal.

12. The information processing device according to claim 11, wherein the controller receives the specification information of the display device connected to the terminal from the terminal via the network, determines after reception of the specification information whether or not the specification information of the display device is stored in the memory, refers to update date and time information of the display output set value of the display device for each specification stored in the memory when the specification information of the display device is stored in the memory as a result of the determination, determines a display output set value of the display device from the terminal based on the received specification information of the display device and the display output set value of the display device for each specification stored in the memory when update date associated with the received specification information of the display device is not the latest, stores the determined display output set value in the memory, generates display information to be displayed on the display device of the terminal based on the input information of the terminal and the display output set value stored in the memory, and transmits the generated display information via the network to the terminal.

13. The information processing device according to claim 11, wherein the controller transmits the display information via the network to the terminal, and after transmission of the display information, modifies the display output set value stored in the memory to a display output set value specified by a user.

14. The information processing device according to claim 12, wherein the controller, when the determined display output set value is stored in the memory, updates update date and time information of the display output set value stored in the memory.

15. The information processing device according to claim 11, wherein the controller receives the specification information of the display device connected to the terminal via the network from the terminal, determines after reception of the specification information whether or not the specification information of the display device is stored in the memory, determines a display output set value of the display device from the terminal based on communication end date information of the display output set value of the display device for each specification stored in the memory when the specification information of the display device is stored in the memory as a result of the determination, or based on the received specification information of the display device and the display output set value of the display device for each specification stored in the memory when the communication end data associated with the received specification information of the display device is not the latest, stores the determined display output set value in the memory, generates display information to be displayed on the display device of the terminal based on the input information of the terminal and the display output set value stored in the memory, and transmits the generated display information via the network to the terminal.
